(19) United States
(12) Patent Application Publication
(10) Pub. No.: US 2003/0031179 A1
(43) Pub. Date: Feb. 13, 2003

(54) Self-updateable longest prefix matching method and apparatus

(76) Inventor: Jintae Oh, St. Louis, MO (US)

Correspondence Address: Grant D. Kang, Esq., Thompson Coburn, LLP, One Firstar Plaza, St. Louis, MO, 63101, US

(21) Appl. No.: 09/924,786

(22) Filed: Aug. 8, 2001

(51) Int. Cl. H04L 12/56

(52) U.S. Cl. 370/392; 370/401

(57) ABSTRACT

A forwarding table periodically receives updates, and when the forwarding table receives a new entry in such an update, a set of entries having a valid prefix of the new entry is spanned by a correcting window. The correcting window has a correcting window size equal to the bit-length of the valid prefix. A set of target entries is identified in the correcting window such that each of the target entries in the set has a hierarchy pointer value less than the correcting window size. The entry includes a routing tag, and the routing tag is added to the routing tag field in the set of target entries. Additionally, the correcting window size is added to the hierarchy pointer field in the same set of target entries. The forwarding table can also replace prefixes that are removed in a similar manner with a replacement entry has a replacement hierarchical pointer value less than the replacement correcting window size.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

This invention relates generally to a router and, more particularly to the management of routing addresses and routing information in a forwarding table,

2. Description of Related Art

Internet data travels over a packet switching network. For example, in an e-mail message, the data in the message is broken into packages that are approximately 1,500 bytes long. Each package receives a wrapper that includes information on the sender's address, the receiver's address, the package's place in the entire message, and how the receiving computer can be sure that the package arrived intact.

An internet router reconfigures the paths that the data packets take because the router examines the information surrounding the packets. Every piece of equipment that connects to a network has a physical address which is an address that is unique to the piece of equipment that is connected to the network and corresponding to an Internet Protocol address (IP). Thus, if a desktop computer is connected to the internet, the computer has an IP address that is part of the TCP/IP network protocol. The router scans the destination address and matches the IP address against rules stored in the router, such as in a table. The rules will direct that packets in a particular group of addresses should go in a specific direction.

Identifying the IP address is a major task. IP addresses are often 32 bit numbers, normally expressed as four (4) numbers between 0 and 255, each number being separated by a decimal point, resulting in a set of numbers between 000.000.000.000 and 255.255.255.255. A typical IP address for Internet Protocol Version 4 (“IP V4”) is a 32 bit IP address because each of the four numbers in the IP address can be expressed by an eight-bit binary number between 00000000 and 11111111. Faster identification of the IP address permits faster switching of the packets. Therefore, the prior art has focused its efforts on improving and accelerating the identification of IP addresses.

U.S. Pat. No. 6,011,795 (“the '795 patent”) discloses a controlled address expansion method using a two-step process called Address Expansion and Prefix Capture. This method is used to expand prefix tables. Specifically, the address expansion step expands a prefix, 1*, into 3 bits: 100, 101, 110 and 111. The prefix capture step generally limits the expansion of a prefix when another prefix is already being used in the routing table. For example, expanding prefix 10* to a 3 bit prefix results in 100 and 101. However, if 101 already exists on the table, only 100 will be selected as the expanded prefix for 10*.

A router has a routing table and a forwarding table. A processor in the router manages the routing table, and the forwarding table is used to find the routing information for the router. The routing table contains prefixes such as 1*, 0*, 10*, etc. and is used to create the forwarding table. The forwarding table has the actual routing information for the router. The two step process utilized by the '795 patent must use the routing table in addition to the forwarding table to update the forwarding table. The reason for the combined operation is that the prefix capture step must use the routing table to determine the existing prefix. The processor must manage the routing table and the forwarding table together to calculate any updated entries for the forwarding table, and this results in increased cost of the router and a decrease in the speed of the router.

The '795 patent requires an extremely large table to build the forwarding table because the receiving prefixes need to be expanded by a pre-selected stride length of prefix table. This large amount of memory that is required cannot be implemented by current commercial SRAM. In addition, this method prevents the high performance packet lookup processing that is required by current state of the art packet processing technology. Accordingly, the method of the '795 patent requires a significant amount of extra memory to maintain the information within the forwarding table. The amount of extra memory will further need to be increased with an increase with the number of data packets in the routing table.

Accordingly, new approaches are needed to reduce the amount of memory required. One such new approach has been proposed by Huang and Zhao. See “Novel IP-Routing Lookup Scheme and Hardware Architecture”, IEEE Journal on Selected Areas in Communications, Vol. 17, No. 6, June 1999. Huang and Zhao have proposed a method for IP V4. The new method uses a fixed length pointer and offset for the pointer. The incoming IP packet is divided into two parts, segment and offset. The segment consists of the first 16 bits of the IP address. The segment generates a pointer. The offset is the number of the remaining valid prefixes of the IP packet. The offset of the pointer decides the amount of memory to be assigned to the pointer. This new method assigns a variable size of memory for each IP packet based on the valid bits of the IP packet.

Although the method proposed by Huang and Zhao will reduce the amount of memory required, it must calculate memory content by sorting the incoming IP packets based on segments for determining the existence of any duplicated memory content. Thus, whenever a new prefix is added to the table, where some contents of the update area are already used for other prefixes, the table must be reconstructed by the processor, and the contents must be downloaded into the table. As a result, this proposed method carries the disadvantage that it must recalculate the forwarding table and re-download the contents into the table whenever a new prefix is added to the table or removed from the table. Therefore, the method requires a duplicated forwarding table—one table used for updating, and the other table used for lookup.

### BRIEF SUMMARY OF THE INVENTION

It is in view of the above problems that the present invention was developed. The invention is an independent forwarding table with fixed-length addresses and a method for managing prefixes in the forwarding table without accessing the routing table while making updates to the forwarding table. Accordingly, during the update procedure, the forwarding table is made independent from the routing table. In addition to the fixed-length address and its respective routing information, the forwarding table includes a hierarchy pointer field and a related hierarchical compare window to eliminate any need for comparing prefixes in the routing table. The hierarchical compare window includes a correcting window that spans a set of entries in the forwarding table and a compare window that spans a different set of entries in the forwarding table. Additionally, the forwarding table has an expansion pointer to link a mother branch with a daughter branch for tree construction. The forwarding table also has an odd field and an even field that identify any expansion in each half of a daughter branch. The forwarding table initially has hierarchy pointer values set to zero and has no routing information for the entries, and the routing table initially populates the forwarding table.

The forwarding table periodically receives updates, and when the forwarding table receives a new entry in such an update, a set of entries having the valid prefix of the new entry is spanned by the correcting window. The correcting window has a correcting window size equal to the bit-length of the valid prefix. A set of target entries is identified in the correcting window such that each of the target entries in the set has a hierarchy pointer value less than the correcting window size. The entry includes a routing tag, and the routing tag is added to the routing tag field in the set of target entries. Additionally, the correcting window size is added to the hierarchy pointer field in the same set of target entries.

The forwarding table can also replace prefixes that are removed. When the forwarding table receives a prefix to be removed from the forwarding table, a replacement correcting window is selected according to the prefix. A set of target replacements in the replacement correcting window is identified. In the set of target replacements, the routing tag is removed from the routing tag field and the hierarchy pointer value is removed from the hierarchy pointer field. Additionally, a replacement entry is identified for the removed routing tag and the removed hierarchy pointer value. The replacement entry has a replacement hierarchical pointer value less than the replacement correcting window size and includes a replacement routing tag. The prefix removal is completed by entering the replacement routing tag into the routing tag field and entering the replacement hierarchy pointer value into the hierarchy pointer field for the set of target replacements.

The addition of new entries into the forwarding table only requires receiving a new entry, without any comparison of prefixes in the routing table. Similarly, the replacement of prefixes only requires receiving the prefix to be removed, without any comparison of prefixes in the routing table. Accordingly, updates to the forwarding table are performed without any comparison of the routing table prefixes.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a segment of a forwarding table and the process of updating the forwarding table with new entries;

FIG. 2 illustrates the process of replacing a prefix;

FIG. 3 illustrates a tree structure with a mother branch and an enabled daughter branch;

FIG. 4 illustrates a preferred tree structure; and

FIG. 5 illustrates a tree structure with a daughter branch that is not enabled.

### DETAILED DESCRIPTION OF THE INVENTION

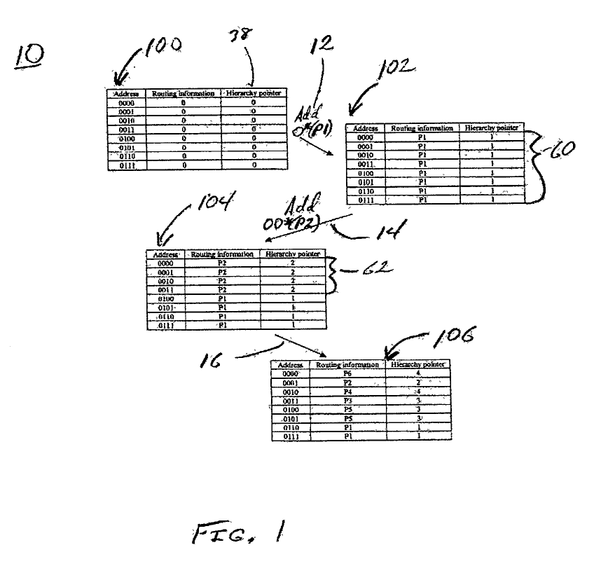

Referring to the accompanying drawings in which like reference numbers indicate like elements, FIG. 1 generally illustrates a forwarding table 10 in its initial state 100 and several periodic updates 102, 104, 106 in which new entries 12, 14, 16 are respectively added to the forwarding table 10. The structure of the forwarding table 10 is preferably implemented in router hardware. However, the forwarding table 10 can also be created in software and is not limited to router hardware applications.

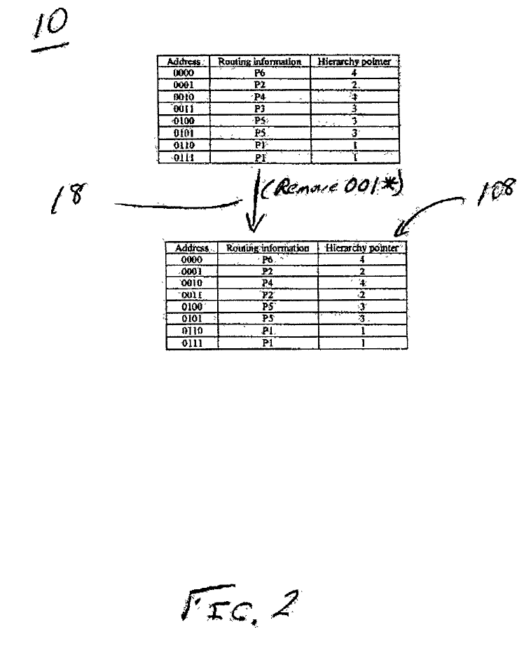

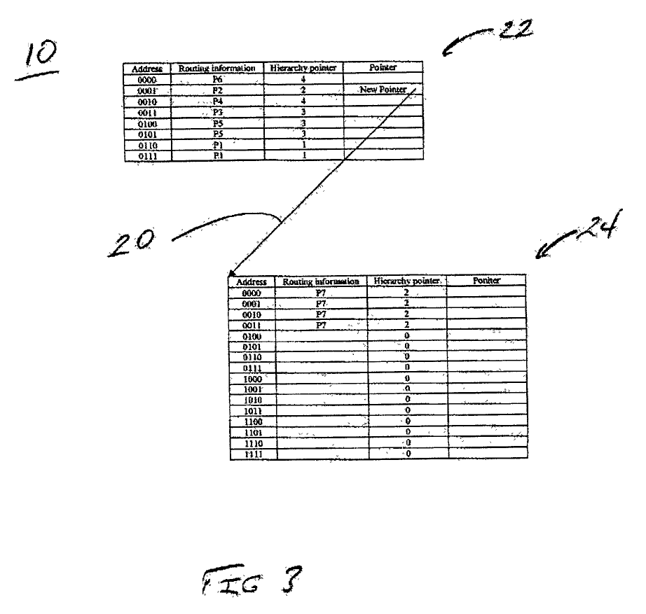

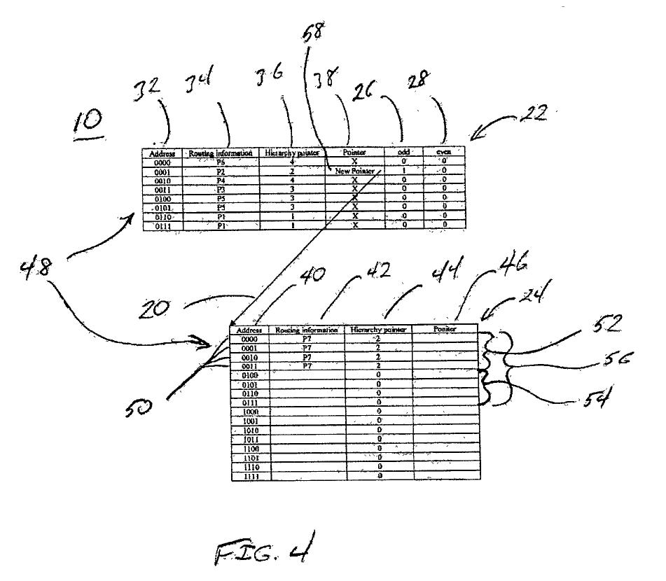

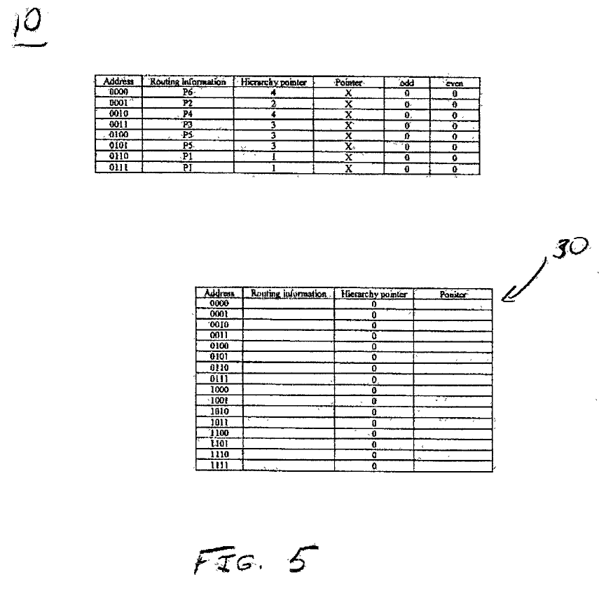

FIG. 2 generally illustrates the forwarding table 10 according to the final update 104 in FIG. 1 and illustrates another update 106 in which a 001* prefix 18 is replaced in the forwarding table 10. FIG. 3 generally illustrates the forwarding table 10 according to the final update 104 in FIG. 1 with the addition of a basic tree structure 20 of the forwarding table 10. The basic tree structure 20 has a mother branch 22 and an enabled daughter branch 24. FIG. 4 generally illustrates a preferred embodiment of the present invention. The forwarding table 10 in FIG. 4 has the same entries as in FIG. 3 and has two additional fields, an odd field 26 and an even field 28. FIG. 5 generally illustrates the forwarding table 10 in which a different daughter branch 30 is not enabled.

Returning again to FIG. 4, the structure of the forwarding table 10 in the preferred embodiment includes the mother branch 22 and the daughter branch 24. The mother branch 22 of the forwarding table has an address field 32, a routing tag field 34, a hierarchy pointer field 36, a pointer field 38, and the odd field 26 and the even field 28. Similarly, the daughter branch 24 has a daughter branch address field 40, a daughter branch routing tag field 42, a daughter branch hierarchy pointer field 44, and a daughter branch pointer field 46. The forwarding table 10 contains a plurality of entries 48 in the respective fields in both the mother branch 22 and the daughter branch 24. In particular, the address field 32, routing tag field 34, hierarchy pointer field 36, pointer field 38, and the odd field 26 respectively contain fixed-length addresses (0000-0111), routing tag information (P1-P6), hierarchy pointers (1-4), an expansion pointer (New Pointer) and an expansion identifier (0-1). The functions of the entries in each of these fields are discussed below.

Although a different bit-length could be selected for the address field 32, containing eight-bit addresses (00000000-11111111), the address field 32 must maintain a fixed bit-length for each address of all entries in the mother branch 22 of the forwarding table 10 for whatever length is selected. Similarly, the daughter branch 24 has a daughter address field 40 with a fixed-bit length. The daughter fixed-bit length and the mother fixed-bit length may be equal to each other but this is not a requirement. Accordingly, it is possible for the daughter fixed-bit length of the daughter branch 24 to be a different length than the fixed-bit length of the mother branch 22.

As discussed in detail below, a set of entries 50 in the daughter branch 24 can be added based on a new prefix of 000100* with associated routing information P7. The address 0001 of the entry in the mother branch 22 is filtered from the new prefix 000101* to produce a daughter branch valid prefix of 00*. Updating the forwarding table 10 is performed using a daughter branch correcting window 52 that spans the set of entries 50 (0000-0011) in the daughter branch 24. Accordingly, the daughter branch correcting window 52 is defined by the daughter branch valid prefix 00*. If the prefix 000100* is being removed, a replacement entry for the set of entries 50 is found using a compare window 54. Generally, the compare window 54 is selected by truncating the prefix for the correcting window and then excluding the set of entries in the correcting window. Therefore, compare window 54 is selected using prefix 01* by truncating the daughter branch valid prefix 00* to 0* and excluding the set of entries in the correcting window (00*).

The combination of the correcting window 52 and the compare window 54 is generally referred to as the hierarchical compare window 56. The hierarchical compare window size is measured by the bit-length of the hierarchical compare window 56 and defines the value of the hierarchy pointers in the hierarchy pointer fields 36, 44. In particular, when adding a routing tag to a set of target entries in the forwarding table 10, the correcting window size is entered into the hierarchy compare field 36, 44 for each entry in the set of the target entries. Similarly, when removing a prefix from the forwarding table 10, the correcting window size is used to identify the set of target entries. For each entry in the set of target entries, the value in the hierarchy compare field 36, 44 must equal to the correcting window size. It should be understood that a set is being used in its broadest meaning and can include a single entry or a group of entries. Accordingly, a set of target entries could be a single entry or a group of entries. In some circumstances, a set could also be a null set with no entries, and this usually results in altering the hierarchy of the hierarchical compare window until at least one entry is contained within the set.

FIG. 4 particularly illustrates a daughter branch 24 that is expanded from the address entry 0001 in the mother branch 22. Accordingly, the pointer field 38 for address entry 0001 contains an expansion pointer 58 that connects the daughter branch 24 to the mother branch 22. If there is no replacement routing information in the daughter branch when all of the routing information in the daughter branch is removed, the expansion pointer 58 is removed from the mother branch 22, and the expansion pointer 58 is returned to a pointer administrator. The pointer administrator is a means for managing expansion pointers.

Given the preceding structural overview of the forwarding table 10, the method for managing the forwarding table 10 is now discussed in detail. The forwarding table 10 is segmented into the fields for the entries. The forwarding table periodically receives updates, beginning with the forwarding table 10 receiving a new entry to be added to the forwarding table 10, including a valid prefix and a routing tag, or receiving a prefix to be removed from the forwarding table 10. The forwarding table 10 is updated using valid prefixes and ignoring the “don't care bits” of the prefixes. The “don't care bits” in the prefixes are generally designated by an asterisk (*). Given that address fields 32, 40 contain fixed-length addresses, valid prefixes identify sets of addresses in the address field. For example, given an address field that contains eight-bit addresses (not shown), prefix 001* has a valid prefix 001 that identifies the set of addresses from 00100000 through 00111111, and the present invention could function with such addresses. For the specific examples discussed below, the address fields 32, 40 have four-bit addresses.

Generally, when the forwarding table 10 receives a new entry in an update, a set of entries are defined by the correcting window. In particular, the correcting window is selected according to the valid prefix. The correcting window has a correcting window size equal to the valid prefix bit-length, and the correcting window spans the set of entries in the table that include the valid prefix. Each entry in the set of entries has an address and a hierarchy pointer value. From the set of entries in the correcting window, a set of target entries is identified such that each of the target entries in the set of target entries has a hierarchy pointer value less than the correcting window size. For each target entry in the set of target entries, the routing tag is added to the routing tag field and the correcting window size is also added to the hierarchy pointer field.

Returning to FIG. 1, a particular example is presented when a new entry is added to the forwarding table 10. As discussed above, target entries are selected according to the correcting window, where the update condition is determined by comparing the correcting window size with the hierarchy pointer value. In particular, entries can be updated if the hierarchy pointer value is less than the correcting window size. In the initial state 100 of the forwarding table 10, all values in the hierarchy pointer field 38 are initially zero. Adding the 0* (P1) entry 12, prefix 0* with a routing tag P1, according the process discussed above produces the first update 102 of the forwarding table 10. In this case, the set of entries in correcting window 60 include 0000 through 0111, a total of 8 entries, and the correcting window size is one. All eight entries are included in the set of target entries because the hierarchy pointer value for each of these entries is zero which is less than the correcting window size (0<1). Therefore, as illustrated in the second state 102 of the forwarding table 10, the eight entries are updated with the routing tag P1 and the hierarchy pointer one, the correcting window size. This example illustrates the situation where the set of target entries is commensurate with the set of entries in the correcting window 60.

The third state 104 shows the results of a case when 00*(P2) entry 14 is added to the forwarding table 10. In this case, the set of entries in correcting window 62 include 0000 through 0011 , a total of four entries, and the correcting window size is two. As with the second state 102, all entries in the correcting window 62 are included in the set of target entries because the hierarchy pointer value for each of the entries is one which is less than the correcting window size (1<2). Therefore, as illustrated in the third state 104 of the forwarding table 10, the four entries are updated with the routing tag P2 and the hierarchy pointer value two, the correcting window size. The final state 106 shows the forwarding table 10 after several periodic updates 16. The periodic updates 16 include 001* (P3) entry, 0010 (P4) entry, 010* (P5) entry, and 0000 (P6) entry 16 and are sequentially added to the forwarding table 10 following the entry procedure discussed above.

Returning to the more general update procedure, the forwarding table 10 can also replace prefixes that are removed without comparing prefixes in the routing table. When the forwarding table receives a prefix to be removed from the forwarding table, a replacement correcting window is selected according to the prefix. The replacement correcting window has a correcting window size equal to the valid prefix bit-length. A set of target replacements in the replacement correcting window is identified. In the set of target replacements, the routing tag is removed from the routing tag field and the hierarchy pointer value is removed from the hierarchy pointer field. Additionally, a replacement entry is identified for the removed routing tag and the removed hierarchy pointer value. The replacement entry must have a replacement hierarchical pointer value less than the replacement correcting window size. The replacement entry includes a replacement routing tag, and as discussed in detail below, the replacement entry may be found in the correcting window or the compare window. The prefix removal is completed by entering the replacement routing tag into the routing tag field and entering the replacement hierarchy pointer value into the hierarchy pointer field for the set of target replacements.

Again, the replacement correcting window spans the set of entries in the forwarding table 10 that include the valid prefix, and each entry in the set of entries includes an address and a hierarchy pointer value. The set of target entries is again identified from the set of entries in the replacement correcting window such that each entry in the set of target entries has a hierarchy pointer value equal to the replacement correcting window size.

As presented above, the replacement entry may be found in the replacement correcting window or the compare window, and this is due to the hierarchical nature of the replacement correcting window and the compare window and their exclusivity within the hierarchical compare window. First, the replacement correcting window is searched for the replacement entry. If the replacement entry is not found in the replacement correcting window, the prefix is hierarchically truncated to produce a reduced prefix. The compare window is selected according to the reduced prefix in a manner similar to the correcting window, with the exception that the compare window preferably excludes the correcting window from its range. The compare window is searched for the replacement entry. Again, if the replacement entry is not found in the compare window, the reduced prefix is hierarchically truncated, and a higher order compare window is selected using the truncated reduced prefix. The higher order compare window excludes the replacement correcting window and the first compare window and is searched for the replacement entry. In an iterative manner, the prefix is again truncated, a different compare window that excludes the previous hierarchical compare windows is selected, and the different compare window is searched until a replacement entry is found.

Returning to FIG. 2, a particular example is presented when a prefix is to be removed from the forwarding table 10. To remove 001* prefix 18 from the forwarding table, the set of entries for the correcting window include the entry having ‘0010’ address and the entry having the ‘0011’ address. The ‘0010’ entry has a hierarchical pointer value of four which is not equal to the correcting window size of three (4≠3). Therefore, the ‘0010’ entry does not belong to the prefix 001*. The ‘0011’ entry 0011 has a hierarchical pointer value of three and is the only entry in the set of target entries. The routing tag and the hierarchical pointer value are removed from the forwarding table 10 for the ‘0011’ entry.

After removing the routing tag and the hierarchical pointer value from the ‘0011’ entry, the forwarding table 10 is searched for another entry to replace the removed entry. The replacement entry must have a hierarchical pointer value that is less than the correcting window size of three. No such entry exists in the correcting window for this example.. A compare window that starts with the same prefix as the removed set of target entries, 001* prefix 18, and having a window size of two or one may contain a replacement entry. The compare windows are searched in the order of their hierarchy, preferably truncating the prefix one bit at a time.

The compare window of size two is first selected by truncating the prefix from 001* to 00* and excluding the entries in the correcting window. In this particular example, the ‘0010’ entry and the ‘0011’ entry already exist in the correcting window and they are therefore excluded from the compare window. The effective result is that the least significant bit from the prior window is flipped (001* is flipped to 000*). Accordingly, the ‘0000’ entry and the ‘0001’ entry need to be searched for a hierarchical pointer value that is less than the correcting window size of three. The ‘0000’ entry has a hierarchical pointer value of four which is not less than three and cannot be used as the replacement entry. The ‘0001 entry has a hierarchy pointer value of two and is less than the size of the correcting window size of three (2<3). The prefix removal and replacement is completed by replacing the contents of the ‘0011’ entry, except for the address ‘0011’, with the contents of the ‘0001’ entry. The forwarding table 10 is illustrated following the removal update 108.

If a hierarchical pointer less than the correcting window had not been found, the next higher order compare window would have to be searched by reducing the prefix 00* to 0*. In this case, eight branches start with 0* and the hierarchical compare window size is one. However, ‘0000’, ‘0001’, ‘0010’, and ‘0011’ have already been searched and are excluded from this compare window, resulting in entries starting with the 01* prefix that need to be searched. Again, the effective result is that the least significant bit from the prior window is flipped (00* is flipped to 01*).

Returning to FIG. 3, tree expansion is generally described by generating and expanding a daughter branch in the forwarding table 10 for an entry in the mother branch. In the particular example, the mother branch entry has address ‘0001’, a hierarchy pointer value of two (00* prefix), and an expansion pointer that indicates the daughter branch is expanded. The hierarchical pointer value of each entry in the daughter branch is used as a current occupied hierarchy. During the prefix removal process, if there are no more active entries in the daughter branches, all hierarchical pointer values of the daughter branch are zero. In such a condition, the expansion pointer can be removed from the pointer field of the mother branch. When the daughter branch is initially expanded due to a new prefix entry with at least one active entry, the expansion pointer is added to connect the daughter branch to the mother branch in the longest prefix matching forwarding table. Again, by using the hierarchical pointer, the routing table is not necessary during the pointer generation and removing operation. When implementing the longest prefix matching table with tree expansion in hardware, it is preferable to manage the expansion pointers with a hardwired pointer administrator.

The general method for managing a daughter branch from a particular address in the mother branch is described below and is followed by the particular examples in FIGS. 3-5. The general method for generating and expanding the daughter branch includes:

The forwarding table is further segmented with a pointer field;

An expansion pointer is set in the pointer field for particular address, thereby connecting said daughter branch with said mother branch entry.

The daughter branch is also segmented with a daughter branch address field, a daughter branch routing tag field, and a daughter branch hierarchy pointer field; and the daughter branch address field has a daughter branch fixed bit-length.

The forwarding table receives a new entry, including a new prefix that has a bit-length greater than the fixed bit-length of the address field in the mother branch and also including routing tag information.

The particular address of the mother branch is filtered out from the new prefix to produce a daughter branch valid prefix with a daughter branch bit-length.

The daughter branch is populated with the routing tag information in the daughter branch routing tag field and with the daughter branch bit-length in the daughter branch hierarchy pointer field.

In particular, the daughter branch is populated as follows:

The daughter branch correcting window is selected according to the daughter branch valid prefix.

A set of daughter branch target entries is identified in the daughter branch correcting window.

The routing tag information is added to the daughter branch routing tag field for the set of daughter branch target entries and the daughter branch bit-length is also added to the daughter branch hierarchy pointer field for the set of daughter branch target entries.

In addition to the method described above, the preferred method for generating and expanding a daughter branch includes:

Further segmenting the forwarding table with an odd field and an even field.

Flagging the odd field for the particular address, thereby indicating that at least one active entry with a most significant bit of zero exists in the daughter branch.

Flagging the even field for the particular address, thereby indicating that at least one active entry with a most significant bit of one exists in the daughter branch.

The general method for removing the routing tag information and the daughter branch bit-length from each entry in the set of daughter branch target entries includes:

Unflagging the odd field for the particular address, thereby indicating that each entry starting with zero is inactive in the daughter branch.

Unflagging the even field for the particular address, thereby indicating that each entry starting with one is inactive in the daughter branch.

Removing the expansion pointer from the pointer field for the particular address in the mother branch, thereby indicating that the daughter branch is not enabled.

FIG. 3 particularly illustrates an example in which a forwarding table 10 is updated with a new prefix ‘000100*’ (P7) using the tree structure and process generally described above. In this case, the entry ‘0001’ in the mother branch requires an expansion pointer to connect a daughter branch. To populate the daughter branch, the mother branch entry ‘0001’ is filtered out from the new prefix. The first four bits of the prefix are now only used for tree expansion. A daughter branch valid prefix ‘00*’ is formed from the remaining two bits. Therefore, the hierarchical pointer for the prefix 000100* has a hierarchical pointer value of two.

To expand the daughter branch, at least one of the entries in the daughter branch must be activated. Correspondingly, the basic condition to remove an expansion pointer is satisfied when the hierarchy pointer values of each entry in the daughter branch is zero. Without the odd field and the even field, the daughter branch would have to be accessed for each entry in memory. To reduce the number of accesses into the memory, this invention also contemplates the use of the odd field and the even field to respectively indicate whether addresses of daughter branches start with 0* or 1* when a mother branch expands. The structure of the mother branch with the odd field and the even field is particularly illustrated in FIG. 4. The flag in the odd field of the mother branch indicates that the daughter branch has at least one active entry for those entries that start with 0*. The lack of a flag in the even field indicates that the daughter branch does not have any active entry for those entries that start with 1*. Accordingly, when 000100* is tree expanded, only the odd field in the mother branch is active.

The removal of 000100* from the forwarding table is illustrated in FIG. 5. The first four most significant bits ‘0001’ of the prefix is used to find the daughter branch. In the daughter branch, the correcting window is selected from the daughter branch valid prefix 00* (‘0000’ entry to ‘0011’ entry). Each of these four entries has a hierarchical pointer value of two, which is equal to the correcting window size of two. Therefore, all four entries can be removed. To replace the entries in the correcting window, the compare window is selected by 0*, but 00* is already used for the correcting window, and the remaining 01* is selected for the compare window. The hierarchy pointer value of the ‘0100’ entry is zero. Therefore, the update of the daughter branch is completed by copying the content of ‘0100’ to the entries in the correcting window.

After the update of the daughter branch is completed, the hierarchical pointer value of the entries that start with 0* are all zero. It is also known that only the odd field had an expanded daughter branch by reading the previous mother branch entry and noting that the even field has a value of zero, indicating that all of the hierarchical pointers for the entries that start with 1* are also zero. Therefore, there is no need of an expansion pointer for the daughter branch because all of the hierarchical pointers in the daughter branch are zero. Accordingly, the content of the mother branch is modified to update the pointer expansion of mother branch. When the daughter branch corresponding to the odd field became inactive, the mother branch no longer needs the pointer expansion value in the pointer field. Removing the pointer expansion from the mother branch and sending it back to the pointer administrator completes the prefix removal process.

For the look-up process of the forwarding table 10, it is only necessary to look-up a daughter branch whose pointer field is enabled in the mother branch with an expansion pointer. Additionally, when the pointer field is enabled, it can be checked from the mother branch whether addresses of daughter branches start with 0* or 1*. Even if the pointer of the mother table indicates that successive look-ups are needed, the odd field and the even field in the mother table reduces the number of accesses into memory.

In view of the foregoing, it will be seen that the several advantages of the invention are achieved and attained. The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method for managing a plurality of entries in a forwarding table, comprising the steps of:
(a) segmenting the forwarding table into an address field, a routing tag field, and a hierarchy pointer field; said address field having a fixed bit-length;
(b) receiving a new entry, said new entry comprising a valid prefix and a routing tag, said valid prefix having a valid prefix bit-length;
(c) selecting a correcting window according to said valid prefix, wherein said correcting window has a correcting window size equal to said valid prefix bit-length and wherein said correcting window comprises a set of entries in the forwarding table that include said valid prefix, each of said set of entries further comprising an address and a hierarchy pointer value;
(d) identifying a set of target entries from said set of entries in said correcting window, wherein each of said set of target entries has a hierarchy pointer value less than said correcting window size; and
(e) adding said routing tag to said routing tag field for each address of said set of target entries and adding said correcting window size to said hierarchy pointer field for each address of said set of target entries.

2. A method for managing a plurality of entries according to claim 1 further comprising the step of replacing a prefix in the forwarding table.

3. A method for managing a plurality of entries according to claim 2, wherein said step of replacing a prefix further comprises the steps of:
receiving a prefix to be removed from the forwarding table;
selecting a replacement correcting window according to said prefix, said replacement correcting window having a replacement correcting window size;
identifying a set of target replacements in said replacement correcting window;
removing said routing tag from said routing tag field and removing said hierarchy pointer value from said hierarchy pointer field for said set of target replacements;
identifying a replacement entry for said removed routing tag and said removed hierarchy pointer value, wherein said replacement entry has a replacement hierarchical pointer value less than said replacement correcting window size and further comprises a replacement routing tag;
entering said replacement routing tag into said routing tag field and entering said replacement hierarchy pointer value into said hierarchy pointer field for said set of target replacements.

4. A method for managing a plurality of entries according to claim 1, wherein the forwarding table further comprises a mother branch entry having a particular address, and wherein the method further comprises the step of generating and expanding a daughter branch in the forwarding table for said mother branch entry.

5. A method for managing a plurality of entries according to claim 4 wherein said step of generating and expanding a daughter branch further comprises the steps of:
further segmenting the forwarding table with a pointer field;
setting an expansion pointer in said pointer field for said particular address, thereby connecting said daughter branch with said mother branch entry; and
segmenting said daughter branch with a daughter branch address field, a daughter branch routing tag field, and a daughter branch hierarchy pointer field; said daughter branch address field having a daughter branch fixed bit-length.

6. A method for managing a plurality of entries according to claim 5, further comprising the steps of:
receiving a new prefix with routing tag information, said new prefix having a bit-length greater than said fixed bit-length of said address field;
filtering out said particular address from said new prefix to produce a daughter branch valid prefix, said daughter branch valid prefix having a daughter branch bit-length; and
populating said daughter branch with said routing tag information in said daughter branch routing tag field and with said daughter branch bit-length in said daughter branch hierarchy pointer field.

7. A method for managing a plurality of entries according to claim 6, wherein said populating step further comprises the steps of:
selecting a daughter branch correcting window according to said daughter branch valid prefix;
identifying a set of daughter branch target entries in said daughter branch correcting window; and
adding said routing tag information to said daughter branch routing tag field for said set of daughter branch target entries and adding said daughter branch bit-length to said daughter branch hierarchy pointer field for said set of daughter branch target entries.

8. A method for managing a plurality of entries according to claim 7, further comprising the steps of:
further segmenting the forwarding table with an odd field and an even field;
flagging said odd field for said particular address, thereby indicating at least one active entry starting with zero exists in said daughter branch of said mother branch entry; and
flagging said even field for said particular address, thereby indicating at least one active entry starting with one exists in said daughter branch of said mother branch entry.

9. A method for managing a plurality of entries according to claim 8 further comprising the step of removing said routing tag information and said daughter branch bit-length from each of said set of daughter branch target entries.

10. A method for managing a plurality of entries according to claim 8, further comprising the steps of:
unflagging said odd field for said particular address, thereby indicating each entry starting with zero is inactive in said daughter branch of said mother branch entry;
unflagging said even field for said particular address, thereby indicating each entry starting with one is inactive in said daughter branch of said mother branch entry; and
removing said expansion pointer from said pointer field for said particular address, thereby indicating that said daughter branch is not enabled.

11. A method for managing a plurality of entries in a forwarding table, the forwarding table having an address field, a routing tag field, and a hierarchy pointer field, wherein the address field has a fixed bit-length, comprising the steps of:
(a) receiving a prefix to be removed from the forwarding table, said prefix having a valid prefix bit-length;
(b) selecting a correcting window according to said prefix, wherein said correcting window has a correcting window size equal to said valid prefix bit-length and wherein said correcting window comprises a set of entries in the forwarding table that include said prefix, each of said set of entries comprising an address and a hierarchy pointer value;
(c) identifying a set of target entries from said set of entries in said correcting window, wherein each of said set of target entries has a hierarchy pointer value equal to said correcting window size and further comprises a routing tag;
(d) removing said routing tag from the routing tag field for each address of said set of target entries and removing said hierarchy pointer value from the hierarchy pointer field for each address of said set of target entries;
(e) identifying a replacement entry for said removed routing tag and said removed hierarchy pointer value, wherein said replacement entry has a replacement hierarchical pointer value less than said correcting window size and further comprises a replacement routing tag; and
(f) entering said replacement routing tag into the routing tag field for each address of is said set of target entries and entering said replacement hierarchy pointer value into the hierarchy pointer field for each address of said set of target entries.

12. A method for managing a plurality of entries according to claim 11, wherein said step for identifying a replacement entry further comprises the steps of:
searching for said replacement entry in said correcting window;
hierarchically truncating said prefix to produce a reduced prefix when said replacement entry is not found in said correcting window;
selecting a compare window having said reduced prefix;
excluding said correcting window from said compare window;
searching for said replacement entry in said compare window;
hierarchically truncating said reduced prefix when said replacement entry is not found in said compare window;
selecting a higher order compare window having said truncated reduced prefix;
excluding said correcting window and said compare window from said higher order compare window;
searching for said replacement entry in said higher order compare window; and
repeating said truncating step, selecting step, excluding step and searching steps when said replacement entry is not found.

13. A forwarding table for a router, comprising:
a mother branch containing a plurality of entries, said mother branch further comprising an address field, a routing tag field, a hierarchy pointer field, and a pointer field, wherein said address field, said routing tag field, said hierarchy pointer field, and said pointer field respectively contain a plurality of fixed-length addresses, at least one routing tag, at least one hierarchy pointer, and at least one expansion pointer;
a higher order compare window spanning a set of said plurality of entries; and
an expanded daughter branch connected to said mother branch through said at least one expansion pointer in said pointer field, said daughter branch having at least one entry.

14. A forwarding table according to claim 13, wherein said address field of said mother branch has a fixed bit length.

15. A forwarding table according to claim 14, wherein said daughter branch has a daughter address field with a daughter fixed-bit length.

16. A forwarding table according to claim 15, wherein said daughter fixed-bit length equals said fixed-bit length.

17. A forwarding table according to claim 16, wherein said daughter fixed-bit length does not equal said fixed-bit length.

18. A forwarding table according to claim 13, wherein said higher order compare window further comprises a correcting window spanning an update set of said plurality of entries and a compare window spanning a replacement set of said plurality of entries, wherein said replacement set is exclusive of said update set.

19. A forwarding table according to claim 13, further comprising an odd field and an even field in said mother branch, said odd field and said even field having an expansion identifier for said daughter branch.

20. A forwarding table according to claim 13, further comprising a means for managing said expansion pointer.
